(19) United States
(12) Patent Application Publication
(10) Pub. No.: US 2015/0168613 A1
(43) Pub. Date: Jun. 18, 2015

(54) FRONTLIGHT DIFFUSER WITH INTEGRATED BLACK MASK

(71) Applicant: QUALCOMM Mems Technologies, Inc., San Diego, CA (US)

(72) Inventors: John H. Hong, San Clemente, CA (US); Jian J. Ma, Carlsbad, CA (US); Bing Wen, Poway, CA (US); Tallis Y. Chang, San Diego, CA (US)

(73) Assignee: QUALCOMM Mems Technologies, Inc., San Diego, CA (US)

(21) Appl. No.: 14/133,463

(22) Filed: Dec. 18, 2013

(51) Int. Cl. G02B 5/02; G09G 5/00; G06T 1/20; G06T 1/60; G02B 1/11; G02B 26/08

(52) U.S. Cl. CPC G02B 5/0278; G02B 1/11; G02B 26/0833; G06T 1/20; G06T 1/60; G09G 5/00

(57) ABSTRACT

This disclosure provides systems, methods and apparatus for diffusing light in a display device, such as a reflective display device. In one aspect, the display can include an array of display elements and an optical diffuser forward of the array. The diffuser can include an optically transmissive filler material and a plurality of spaced-apart protrusions extending into the filler material. The protrusions can have varying heights. In some portions of the diffuser, the protrusions may be formed of optically transmissive material, to provide diffusion. In some other portions, the protrusions may be formed of light absorbing material to form a black mask in those sections.

### TECHNICAL FIELD

This invention relates generally to an optical diffuser and, more particularly, to an optical diffuser for diffusing light propagating to and/or from a display.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Reflective displays, such as IMOD-based displays, may experience undesirable optical effects that result from specular reflection. Optical diffusers can be used to diffuse light of visible wavelengths and to mitigate undesirable effects caused by specular reflection. Such diffusers may form part of display devices to, for example, diffuse light that propagates to, from, or both to and from, a display device. To meet market demands and design criteria for devices incorporating diffusers, new diffusers and related devices are continually being developed.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device. The display device can include an array of display elements. An optical diffuser can be disposed forward of the array of display elements. The optical diffuser can have a bottom surface facing the array of display elements. The optical diffuser can include a layer of filler material having a first index of refraction. The optical diffuser can further include a plurality of spaced-apart protrusions having heights substantially perpendicular to the bottom surface and extending into the layer of filler material. At least some of the plurality of protrusions can be optically transmissive and can have varying heights. Each of the plurality of protrusions can have an index of refraction different from the first index of refraction.

In some implementations, the heights of the protrusions can vary substantially randomly. The optical diffuser can also include a transmissive portion and an absorptive portion, each portion comprising protrusions of the spaced-apart protrusions. The transmissive portion can be configured to transmit light to active portions of the display elements. The absorptive portion can be configured to absorb light to prevent the light from impinging on inactive portions of the display elements.

Another innovative aspect of the subject matter described in this disclosure can be implemented in a display device. The display device can include means for displaying image data. The display device can also include means for diffusing light disposed forward of the displaying means. The light diffusing means can include means for transmitting light to the displaying means and means for absorbing light directed towards the display device. The transmitting means can scatter light incident on the diffusing means before the incident light impinges on the displaying means. The absorbing means can absorb at least some of the incident light before the incident light impinges on the display device.

In some implementations, the transmitting means and the absorbing means can be formed in the same layer. The transmitting means and the absorbing means can each comprise a plurality of spaced-apart protrusions having heights substantially perpendicular to the bottom surface and extending into the same layer of filler material. The protrusions can have varying heights. The transmitting means can include a transmissive portion having protrusions that are optically transmissive. The absorbing means can include an absorptive portion having protrusions that are optically absorptive.

Another innovative aspect of the subject matter described in this disclosure can be implemented in a method of manufacturing a display. The method can include providing an array of display elements. An optical diffuser having a layer of filler material and a plurality of spaced-apart protrusions extending into the layer of filler material can be provided. The protrusions can have varying heights and an index of refraction different from an index of refraction of the filler material. The optical diffuser can be attached forward of the array of display elements.

In some implementations, attaching the optical diffuser includes disposing the optical diffuser between the array of display elements and a transparent substrate. Furthermore, in some implementations, the protrusions can be formed using a protrusion material, and providing the optical diffuser can include etching openings in a base substrate, the base substrate including one of the filler material and the protrusion material. The etched openings can be filled with the other of the filler material and the protrusion material.

Another innovative aspect of the subject matter described in this disclosure can be implemented in a method of making an optical diffuser. The method can include providing a layer of optically transmissive material having a first refractive index. The method can further include forming holes extending into the layer of optically transmissive material, at least some of the holes having varying depths. Furthermore, some of the holes can be filled with a second material having a second refractive index lower than the first refractive index. Others of the holes can be filled with a third material having a third refractive index higher than the first refractive index.

In some implementations, filling some of the holes with the second material forms optically transmissive pillars, and filling others of the holes with the third material forms optically absorptive pillars.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a schematic side cross-sectional view of a reflective display device in which incoming light is specularly reflected from display elements.

FIG. 2 is a schematic side cross-sectional view of a reflective display device having an optical diffuser such that incoming light is diffused and is reflected from display elements.

FIG. 3 is a schematic side cross-sectional view of a reflective display device having an optical diffuser.

FIG. 4 is a flowchart illustrating a method of manufacturing a display device having an optical diffuser.

FIG. 5 is an isometric view illustration depicting two adjacent interferometric modulator (IMOD) display elements in a series or array of display elements of an IMOD display device.

FIGS. 6A and 6B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations of an optical diffuser, which can be used in a display device, are disclosed herein. The display can include an array of display elements configured to display an image to a viewer. When the display device includes reflective display elements having smooth reflective surfaces, the surfaces may cause incoming light to be reflected in a specular manner. This specular reflection can cause light from the display to reach the viewer in only a limited range of angles, thereby causing a view cone of a displayed image to be limited. To increase the size of the view cone and improve display qualities, an optical diffuser can be disposed facing a front side of the array of display elements, wherein the front side of the array is the side of the array configured for viewing by a viewer to see a displayed image; in other words, the optical diffuser may be positioned between the array and the viewer.

In some implementations, the diffuser can include a layer of optically transmissive filler material and multiple spaced-apart protrusions extending into the layer of filler material. At least some of the protrusions can be optically transmissive, and the protrusions can have heights that are measured substantially perpendicular to a bottom surface of the diffuser, for example, a surface facing the display elements. The protrusions can have varying heights such that the height of one protrusion can be different from the height of at least some other protrusions. The optical diffuser can have optically transmissive portions and optically absorptive portions, which may be formed by using different materials to form the protrusions.

In some implementations, the heights of the protrusions can vary randomly. For example, various etch processes can be used to form openings that have depths that are substantially random. The substantially random opening depths can be used to define protrusions having heights that vary randomly. For transmissive portions of the diffuser, the randomly varying heights of the protrusions can modify the incoming wavefronts such that light exiting an exit face of the diffuser scatters in multiple directions. The scattered light exiting the exit face of the diffuser can then impinge on the reflective display element at multiple angles, generating diffuse reflection that increases the size of the view cone and improves the perceived image quality of the display over a larger range of viewing angles.

For absorptive portions of the optical diffuser, the protrusions can include an optically absorbing material. In some implementations, the absorptive portions of the diffuser can be positioned to overlie inactive elements of the display. For example, various inactive, structural elements may be positioned between adjacent display elements. When light reflects or scatters from the inactive structural elements and reaches the viewer, image quality may be degraded (for example, such reflection can cause glare and decrease contrast). The overlying absorptive portions of the diffuser can absorb incoming light to block the light from reaching the inactive display elements, thereby improving image quality by, for example reducing glare and improving contrast.

Particular implementations of the subject matter described in this disclosure can be implemented to realize one or more of the following potential advantages. The optical diffuser can increase the useable range of viewing angles for the display. Where the display is reflective, the diffuser can also reduce glare that may be caused by specular reflection off of the reflective display elements. For example, the diffuser can reduce the intensity of “hot spots” caused by the specular reflection of point light sources in the ambient environment. The increase in viewing angles and reduction in glare from specular reflection can be further accentuated in implementations where the diffuser diffuses light that strikes reflective display elements and also diffuses light that reflects away from the reflective display elements.

In some implementations, the disclosed optical diffusers can advantageously include both a transmissive portion configured to transmit scattered light to the reflective display elements and an absorptive portion configured to absorb light rays that would otherwise impinge on structural or inactive elements disposed between adjacent display elements. The transmissive portion can function as a diffuser. Providing both transmissive and absorptive portions in a single diffuser structure can simplify manufacturing and reduce manufacturing costs by eliminating the use of multiple processes and/or components to achieve both transmissive and absorptive functionalities. For example, both the transmissive and absorptive portions can be formed using the same or similar manufacturing processes. Moreover, the thickness of the display device can be reduced.

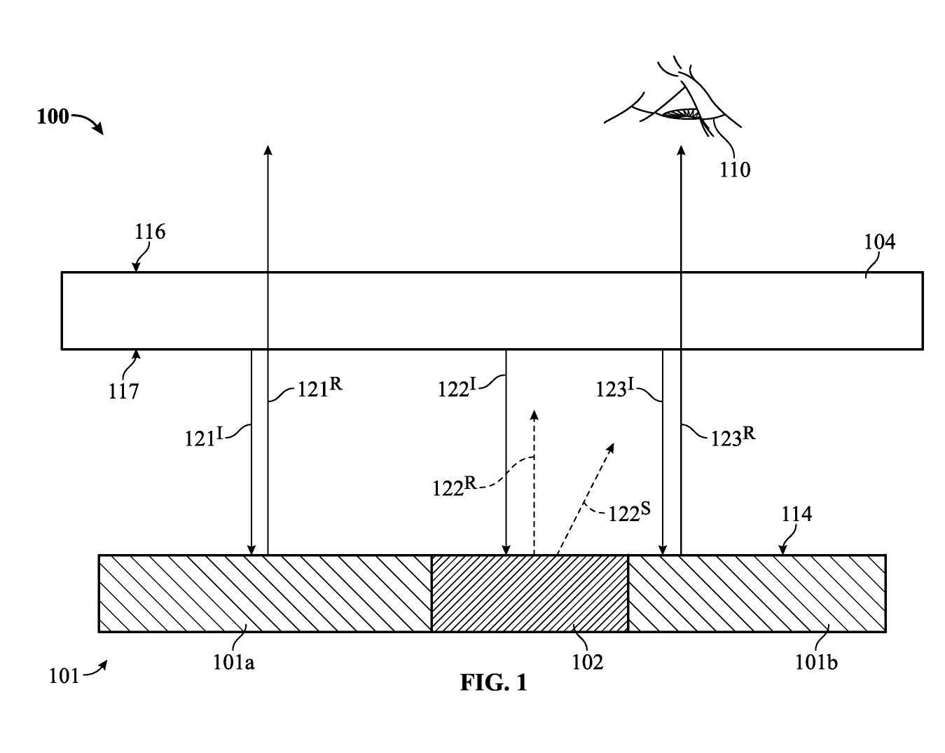

FIG. 1 is a schematic side cross-sectional view of a reflective display device 100 in which incoming light is specularly reflected from display elements 101a and 101b. The display device 100 may include an array 101 of display elements 101a and 101b behind a light guide 104. As used herein, terms such as “behind” and “rearward”, or “front” and “forward”, indicate position relative to the viewer that a display is designed to provide an image for. For example, a part may have a viewer side, facing toward the intended viewer, and a side opposite the viewer side, facing away from the intended viewer. Thus, a part that is in “front” or “forward” of another part is on the viewer side; and a part that is “behind” or “rearward” of another part is on the side opposite the viewer side. With reference to FIG. 1, the viewer is indicated by reference numeral 110.

For ease of illustration, FIG. 1 illustrates only the two display elements 101a and 101b, but any suitable number of display elements may be provided in the array 101. Furthermore, the display elements 101a and 101b may be any suitable type of reflective display element, including, for example, interferometric modulator (IMOD) based display elements. One example of an implementation of an IMOD-based display element is illustrated in FIG. 5. An inactive element 102 may be positioned between the adjacent display elements 101a and 101b. For example, the inactive element 102 may include structural elements that support the display elements 101a and 101b. Accordingly, the inactive elements 102 are not addressable and do not change colors or intensity on command to contribute to the displayed image.

In operation, incident light rays 121^{I}, 122^{I} and 123^{I} may propagate from the light guide 104 toward the array 101. For example, in some implementations, a light source such as a light emitting diode (LED) (not shown) can emit light along a length of the light guide 104. The light guide 104 may include light turning features (such as micro-prisms) that redirect light propagating within the light guide (such as by total internal reflection) so that the light escapes total internal reflection to exit a light output face 117 of the light guide 104 to propagate towards the array 101 of display elements 101a and 101b. In some implementations, the light turning features may be facets, such as triangular facets and/or cone-shaped structures, that can be configured to redirect light (such as by reflection) propagating within the light guide 104. In some arrangements, holograms or other suitable light turning features can be used to redirect light out of the light guide 104. Such redirection of light out of the light guide 104 may also be referred to as light extraction. Incident rays 121^{I} and 123^{I} can impinge on a reflective surface 114 of the display elements 101a and 101b, and incident ray 122^{I} can impinge on the inactive element 102.

The light ray 122^{I} incident on the inactive element 102 may reflect and/or scatter such that reflected ray 122^{R} and/or scattered ray 122^{S} propagates away from the inactive element 102. As explained above, it can be undesirable for light rays 122^{R} and/or 122^{S} reflected and/or scattered from inactive element 102 to reach a viewer 110. For example, the light rays 122^{R} and/or 122^{S} that are reflected and/or scattered from the inactive element 102 may cause the viewer 110 to perceive a glare or other undesirable image artifacts. Accordingly, in some implementations, it can be desirable to reduce or eliminate reflection and/or scattering from the inactive element 102.

The reflective display 100 of FIG. 1 may generate images by light reflections that are more specular in nature than diffusive. In other words, the reflective characteristics of the display elements 101a and 101b may be similar to those of a smooth minor, for example, the reflected angle is about the same as the incident angle. For example, because the rays 121^{I} and 123^{I} are incident on the reflective surface 114 of the display elements 101a and 101b at a substantially perpendicular orientation, reflected rays 121^{R} and 123^{R} are reflected back towards the light guide 104, and are transmitted through a viewing surface 116 of the light guide 104. As shown in FIG. 1, for example, reflected ray 123^{R} may propagate towards and be viewed by the viewer 110, and reflected ray 121^{R} may pass by the viewer 110 such that the viewer 110 does not view the image data carried by reflected ray 121^{R}. Thus, when using specular reflective display elements 101a and 101b, the resulting image may be viewable under only a limited range of viewing angles. Because the viewer 110 can only view rays within a relatively small view cone, the viewer 110 may only see a small portion of the image data to be displayed and large displays may have dark areas since the viewer may be in the view cone for some display elements, but not other display elements. Accordingly, it can be desirable to increase the view cone of the display such that the viewer 110 can view larger angles of the image data.

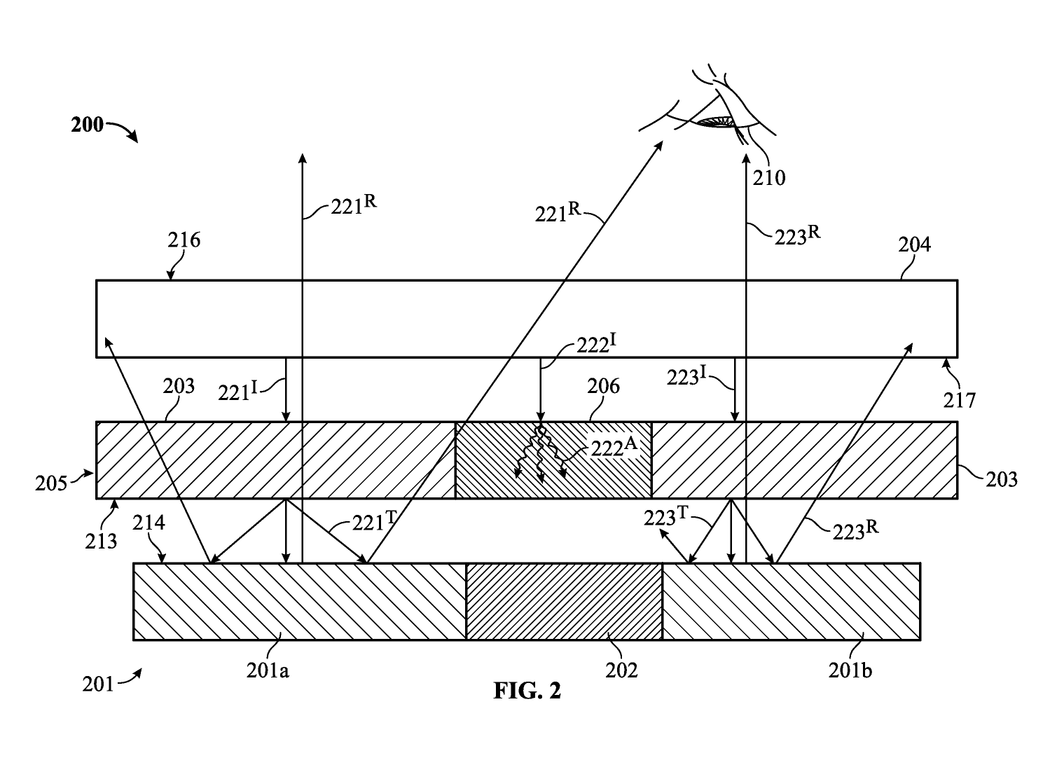

FIG. 2 is a schematic side cross-sectional view of a reflective display device 200 having an optical diffuser 205 such that incoming light is diffused and is reflected from display elements 201a and 201b. Unless otherwise noted, components illustrated in FIG. 2 correspond to like components illustrated in FIG. 1, except the reference numbers are incremented by 100 relative to FIG. 1. As in FIG. 1, the display device 200 of FIG. 2 can include an array 201 of display elements 201a and 201b positioned behind a light guide 204. An inactive element 202 (such as one or more inactive structural components) can be disposed between the display elements 201a and 201b. The display device 200 can also include an optical diffuser 205 positioned forward of the array 201 and between the array 201 of display elements 201a, 201b and the light guide 204. The diffuser 205 can include a transmissive portion 203. In some implementations, the diffuser 205 can optionally include an absorptive portion 206. In such implementations, as shown in FIG. 2, the transmissive portion 203 can overlie the display elements 201a and 201b, and the absorptive portion 206 can overlie the inactive element 202.

To increase the size of the view cone of the display device 200, the diffuser 205 can be placed forward of the reflective display elements 201a and 201b to scatter light rays 221^{I} and 223^{I} that propagate from the light guide 204 to the diffuser 205. For example, light rays 221^{I}, 222^{I} and 223^{I} can propagate from a light output surface 217 of the light guide 204 towards the diffuser 205. The transmissive portion 203 of the diffuser 205 can be structured such that light rays light rays 221^{I} and 223^{I} are scattered before reaching the array 201. For example, the transmissive portion 203 can be structured such that transmitted rays 221^{T} and 223^{T} scatter at a bottom exit surface 213 of the diffuser 205. The transmitted rays 221^{T} and 223^{T} can impinge upon the reflective surface 214 of the reflective display elements 201a and 201b at multiple, different incident angles, which results in multiple, different reflected angles for reflected light rays 221^{R} and 223^{R}. Although the illustrated implementation shows light rays propagating from the light guide 204, it should be appreciated that, in other implementations, light that impinges on the display elements 201a and 201b may be ambient light, or may come from another source. In such other implementations, for example, light from the light guide 204 may be used to augment the ambient light, or the light guide 204 may be omitted or may not be actively emitting light.

The multiple reflected rays 221^{R} and 223^{R} can reflect back through the diffuser 205 and the light guide 204, and can exit the light guide 204 through a viewing surface 216. As shown in FIG. 2, because the diffuser 205 scatters the light before it impinges on the display elements 201a and 201b, rays 221^{R} and 223^{R} reflected from both display elements 201a and 201b can be viewed by a viewer 210. As compared with the display device 100 of FIG. 1, therefore, the viewer 210 can view image data from both display elements 201a and 201b, instead of from only display element 101b as in FIG. 1. Thus, by scattering the light before the light impinges on the display elements 201a and 201b, the view cone and display performance can be substantially increased. Furthermore, in some implementations, the view cone can be sufficiently increased such that multiple viewers separated by a large angle relative to a normal of the viewing surface 216 may be able to view the displayed image at the same time. For example, if two viewers positioned on opposite edges of the display are viewing the display, the diffuser 205 may scatter the light in a view cone that is sufficiently wide such that the two viewers can view the displayed image simultaneously with little to no image degradation. In the implementation of FIG. 2, the optical diffuser 205 is disposed between the light guide 204 and the array 201. For example, in the illustrated implementations, the diffuser 205 may be placed very close to the array 201 to reduce the propagation distance between the diffuser 205 and the array 201. In other implementations, however, the diffuser 205 can be provided above the light guide 204 (for example, over the viewing surface 216) to diffuse light propagating away from the viewing surface 216 and towards the viewer 210.

Unlike the transmissive portion 203, the absorptive portion 206 of the diffuser 205 can be structured to absorb incident rays 222^{I}. As shown in FIG. 2, for example, the absorptive portion 206 can absorb light rays 222^{A} and can block rays 222^{A} from propagating towards the inactive element 202. By preventing the light rays 222^{A} from reaching the inactive element 202, the absorptive portion 206 of the diffuser 205 can advantageously reduce or eliminate glare and/or other image artifacts that may be perceived by the viewer 210 due to light reflecting and/or scattering from the inactive element 202.

With continued reference to FIG. 2, it will be appreciated that the light guide 204 may be replaced by or simply may be a substrate, without providing supplemental illumination for the display device 200. For example, the light guide 204 may simply function as a transparent support, which may provide mechanical support for the filler material and protrusions, for example, during fabrication of the diffuser 205 and/or use of the display device 200. In other implementations, the light guide 204 may be used for supplemental illumination, as discussed herein.

It will be appreciated that the light guide 204 can be formed of one or more layers of optically transmissive material. Examples of optically transmissive materials include the following: acrylics, acrylate copolymers, UV-curable resins, polycarbonates, cycloolefin polymers, polymers, organic materials, inorganic materials, silicates, alumina, sapphire, polyethylene terephthalate (PET), polyethylene terephthalate glycol (PET-G), silicon oxynitride, and/or combinations thereof. In some implementations, the optically transmissive material is a glass. A light source (not shown) can inject light into the light guide 204 such that a portion of the light propagates in a direction across at least a portion of the light guide 204 at a low-graze angle relative to the upper and lower major surfaces of the light guide, such that the light is reflected within the light guide 204 by total internal reflection (TIR) off of the upper and lower major surfaces. In some implementations, optical cladding layers (not shown) having a lower refractive index than the refractive index of the light guide 204 (for example, approximately 0.05 or more lower than the refractive index of the light guide 204, or approximately 0.1 or more lower than the refractive index of the light guide 204) may be disposed on the upper and/or lower major surfaces to facilitate TIR off of those surfaces.

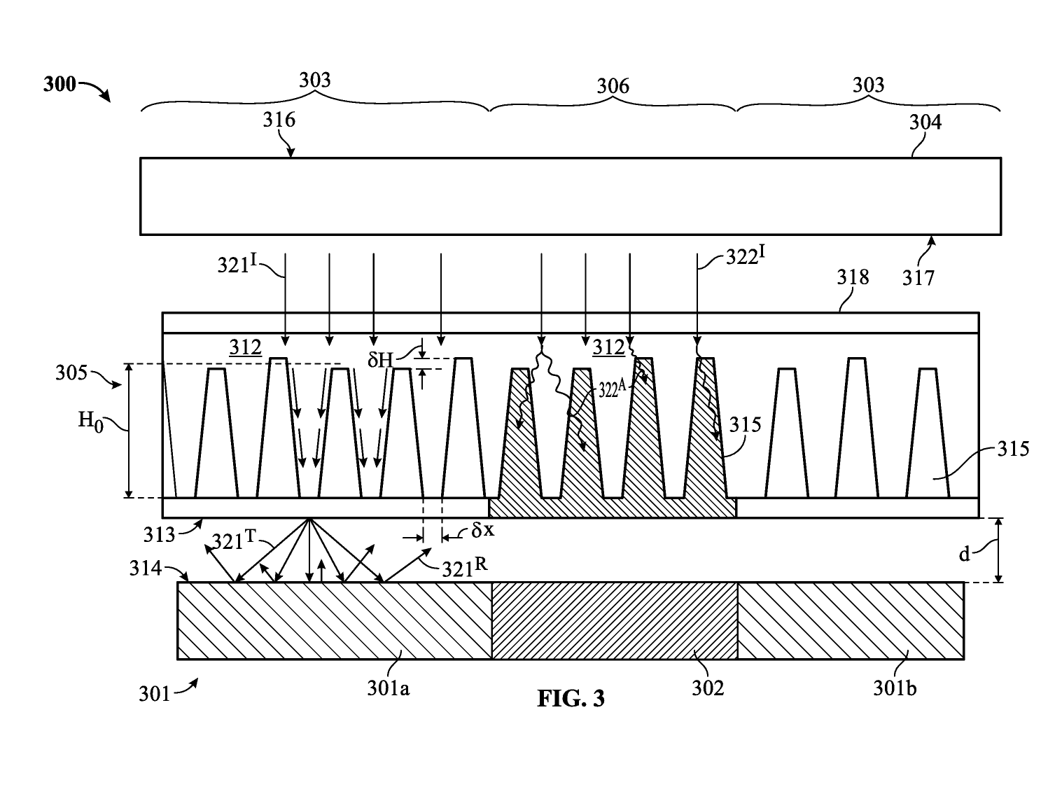

FIG. 3 is a schematic side cross-sectional view of a reflective display device 300 having an optical diffuser 305. Unless otherwise noted, components illustrated in FIG. 3 correspond to like components illustrated in FIG. 2, except the reference numbers are incremented by 100 relative to FIG. 2. As with the implementation of FIG. 2, the display device 300 can include a light guide 304 (for example, glass) and an array 301 of display elements 301a and 301b. The diffuser 305 can be disposed forward of the array 301, between the array 301 and the light guide 304. An inactive element 302 (such as a structural element) can be disposed between adjacent display elements 301a and 301b. For example, the inactive element 302 can include various structural (for example, optically inactive) features that do not contribute information to the image to be displayed.

As with the implementation of FIG. 2, the diffuser 305 can include a transmissive portion 303 configured to transmit light to the optically active display elements 301a, 301b and an absorptive portion 306 configured to block light from reaching the optically inactive element 302. The transmissive portion 303 can generally overlie the display elements 301a and 301b, and the absorptive portion 306 can generally overlie the inactive element 302. In some implementations, the diffuser 305 can be spaced apart from the array 301 by a gap d. In some other implementations, the diffuser 305 can be disposed directly adjacent the array 301. The gap d may be made small enough such that light passing from the diffuser 305 to the array 301 is sufficiently diffused, while not undesirably reducing the perceived resolution of the array 301 due to the intermixing of scattered light rays from different display elements.

The diffuser 305 can include a layer of filler material 312 having a first index of refraction. The first refractive index of the filler material 312 can be relatively high, in comparison to material forming protrusions 315, as described further herein. For example, the filler material 312 can include silicon nitride (Si₃N₄) in some implementations, and the first refractive index (n) of the filler material 312 can be about n>1.5, or n>1.8, for example n=2.

In some implementations, an anti-reflective coating (ARC) 318 can be disposed above the filler material 312 such that the ARC 318 is disposed between the light guide 304 (which may include a light guide plate) and the diffuser 305. The ARC 318 can help to prevent light from reflecting from the diffuser 305 to the viewer.

The diffuser 305 also includes a plurality of spaced-apart protrusions 315 that extend into the layer of filler material 312. The protrusions 315 can extend into the filler material 312 from a bottom exit surface 313 of the diffuser 305. As shown in FIG. 3, the protrusions 315 can be pillars or columns that have a height substantially perpendicular to the bottom exit surface 313. In some implementations, the pillars or columns can be in the shape of a truncated cone which decreases in radius with increasing height. In the transmissive portion 303 of the diffuser 305, the protrusions 315 can have a second index of refraction that is different from the first index of refraction of the filler material 312. The protrusions 315 in the transmissive portion 303 can be formed from a lower index material than the filler material 312. For example, the protrusions 315 can include silicon dioxide or glass, which can have a refractive index of about n<2, or n<1.7, for example n=1.5, in some implementations.

To diffuse incident light rays 321^{I} in the transmissive portion 303 of the diffuser 305, the protrusions 315 can have varying heights, for example, the heights can vary substantially randomly in some implementations. As shown in FIG. 3, for example, the protrusions 315 can have a nominal or average height H₀. The heights of the protrusions 315 can vary by δH, such that each protrusion 315 can have a height in the range of H₀+/−δH/2. For example, as explained below, the protrusions 315 can be defined by etch processes that define openings having variable depths, for example, depths that may vary substantially randomly. For example, the heights of the protrusions 315 can be selected such that, over an area equal to about 10%, 20%, 40%, 65% or 90% of the total area of the side of the diffuser 305 on which the protrusions 315 are disposed, the height distribution of protrusions 315 does not form a repeating pattern. In some implementations, for example, the nominal height, H₀, can be in a range from about 0.5 μm to about 3 μm. The heights can vary within a range δH from about 0.1 μm to about 1.5 μm.

Further, the protrusions 315 can be laterally spaced apart by a distance δx. The distance δx between adjacent protrusions 315 can be about the same across the display 300 in some arrangements; in other arrangements, the distance δx between adjacent protrusions 315 can vary. For example, in some implementations, the distance δx between adjacent protrusions 315 can be in a range from about 0 μm to about 0.5 μm. Furthermore, a diameter or width of each protrusion 315 can be in a range from about 0.3 μm to about 0.5 μm.

By varying the heights of the protrusions 315, the transmitted light rays 321^{T} propagating out of the transmissive portion 303 of the diffuser 305 can be effectively scattered at the bottom exit surface 313 of the diffuser 305. The high aspect ratio pillars or protrusions 315 can also act to guide or funnel light rays 321^{I} incident on a top or input surface of the diffuser 305 towards the bottom exit surface 313. Without being limited by theory, it is believed that the randomly varying heights of the protrusions 315 create a variable effective refractive index that randomizes the phase of light rays 321^{T} emitted from the bottom exit surface 313, such that the light 321^{T} scatters when emitted from the exit surface 313.

As explained above, the scattered light rays 321^{T} emitted from the bottom exit surface 313 of the diffuser 305 can impinge on the display elements 301a and 301b to generate a wide view cone, for example, the scattered light rays 321^{T} can impinge on the display elements 301a and 301b at multiple, different angles. In turn, the light rays 321^{R} reflected from an active surface 314 of the display elements 301a and 301b may be reflected at multiple, different angles. As explained above with respect to FIG. 2, the rays 321^{R} reflected at wide angles may increase the view cone such that a viewer can see the image data from a larger range of viewing angles as the rays 321^{R} propagate through a viewing surface 316 of the light guide 304 to a viewer. For example, in some implementations, the view cone of the display device 300 of FIG. 3 may span a range of angles, relative to a normal to the viewing surface 316 of ±about 50 degrees to about 25 degrees, ±about 35 degrees to about 10 degrees.

The high aspect ratio of the protrusions 315 and funneling of light towards the display elements 301a and 301b can also provide low levels of reflection towards a viewer, thereby improving contrast. Indeed, in the implementation of FIG. 3, the protrusions 315 can substantially prevent reflections from the diffuser 305 such that the ARC 318 may not be used in some arrangements.

The absorptive portion 306 of the diffuser 305 can be structurally similar to the transmissive portion 303 of the diffuser 305. For example, as with the transmissive portion 303, protrusions 315 can extend into the filler material 312, and the protrusions 315 can have varying heights (for example, that vary substantially randomly in some implementations). Unlike the transmissive portion 303, however, in the absorptive portion 306 of the diffuser 305, the protrusions 315 can be formed from a material having an index of refraction higher than the refractive index of the filler material 312. In some implementations, for example, the refractive index of the material used in the protrusions 315 in the absorptive portion 306 can be about n>2.5, n>3, or n≧4. For example, a light absorbing metal or semiconductor (such as amorphous silicon) can be used for the protrusions 315 in the absorptive portion 306.

By providing a higher index material for the protrusions 306, light rays 322^{I} incident on the absorptive portion 306 of the diffuser 305 can be absorbed such that the absorbed light 322A is blocked from reaching the inactive element 302, thereby reducing glare and improving image contrast. Advantageously, the same or substantially similar structure can be used for both the transmissive 303 and absorptive portions 306 of the diffuser 305 by forming protrusions 315 or columns having varying heights. Thus, these features can be patterned simultaneously, thereby simplifying display fabrication.

In sum, in some implementations, the diffuser 305 disclosed herein can increase the view cone by scattering light before it impinges on active portions of the display 300 (for example, reflective display elements), while blocking light that would otherwise impinge on inactive element 302 of the display 300. Advantageously, both the transmissive 303 and absorptive portions 306 can be formed in the same structure or layer.

Further, the diffusers disclosed herein may be used in a front-light display device. For example, the diffusers may be used with various coupling interfaces to enhance light output from a light guide positioned forward of the array of display elements.

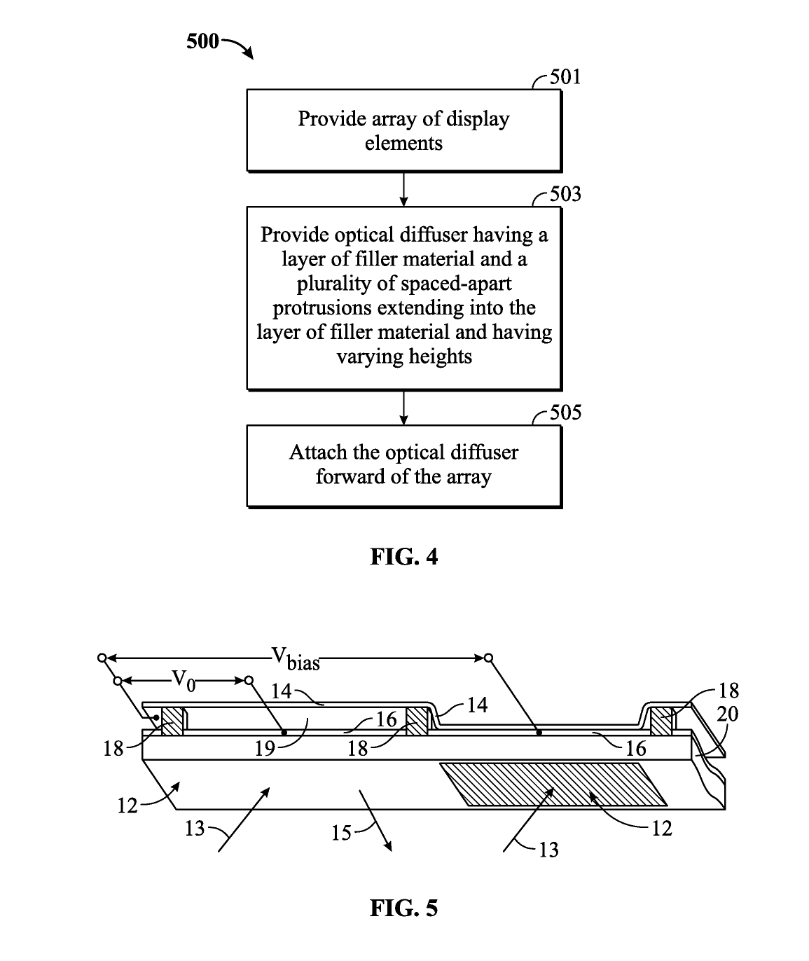

FIG. 4 is a flowchart illustrating a method 500 of manufacturing a display device having an optical diffuser. The method 500 can begin in a block 501 to provide an array of display elements. The array of display elements can include any type of display element. For example, in some implementations, the array can include reflective display elements. An example of a reflective display element that can be used in the displays disclosed herein is an interferometric modulator (IMOD) display element, described in more detail herein.

The method 500 moves to a block 503 to provide an optical diffuser. The diffuser can have a layer of filler material and a plurality of spaced-apart protrusions extending into the layer of filler material. The protrusions can have varying heights. For example, the heights can vary substantially randomly. In some implementations, the filler material can be formed of silicon nitride and can have a refractive index of about n=2. The diffuser can have transmissive and absorptive portions. The transmissive portions can be positioned so that they are disposed over reflective or active surfaces of the display elements when attached to an array of display elements. The transmissive portion can include protrusions formed of a material having a refractive index lower than the refractive index of the filler material. For example, the protrusions of the transmissive portion can be formed of silicon dioxide and can have a refractive index of about n=1.5. The varying heights of the protrusions in the transmissive portion of the diffuser can act to scatter light that is output from an exit surface of the diffuser. The scattered light can impinge on the reflective surfaces of the display elements and can propagate in a relatively wide view cone, which can improve the image quality of the display device.

The absorptive portions can be disposed over inactive elements of the display device. The absorptive portions can include protrusions formed of a material having a refractive index higher than the refractive index of the filler material. For example, the protrusions in the absorptive portion can be formed of a metal or semiconductor (such as amorphous silicon) and can have a refractive index of about n=4. The protrusions in the absorptive portion can act to absorb incident light and block the light from reaching the inactive portions of the display.

The diffuser can be formed using various etch and deposition processes. For example, in some implementations, the protrusions can be defined by etching openings into a suitable base substrate. For example, in some implementations, a layer of the filler material can be formed (for example, by deposition on a substrate), and openings can be etched into the filler material. Various etch processes can be used, including, for example, dry directional etches. To achieve random heights of the protrusions, the etch procedure may include materials and process parameters that etch openings having depths that vary substantially randomly. The openings may be formed by exposing the layer of filler material to an etch through an etch mask having holes. In some implementations, the depths of the openings may be varied by varying the sizes of the holes or by using two or more different etch masks. The conditions (for example, etch duration and/or strength) may be varied with each mask to form different depths with each mask. Any suitable etch processes may be used, including, e.g., wet etching, dry etching, deep reactive ion etching, gray-scale lithography, etc. For example, in grey-scale lithography, mask features of varying heights may be formed in a photoresist layer, and an etch that etches both the mask and an underlying substrate can be used to pattern features of different heights in the substrate. The mask features, by having varying heights, protect the substrate for varying amounts of time before the substrate is etched, thereby allowing features of different heights to be formed in the substrate.

The openings can be filled with material used to define the protrusions (for example, silicon dioxide). In some implementations, the absorptive portions of the diffuser can be masked, and the material used to define the protrusions in the transmissive portions can be deposited into the unmasked openings. Masking the absorptive portions can enable the manufacturer to selectively deposit transmissive material in only the portions of the diffuser that are to be transmissive. Similarly, the transmissive portions can be separately masked, and the material used to define the absorptive portions can be deposited into unmasked openings to selectively deposit the absorptive material.

In some other implementations, however, the material used to define the protrusions can be used as the base substrate, and openings can be etched into the material forming the protrusions. The filler material can be applied into the etched openings.

The method 500 moves to a block 505 to attach the optical diffuser forward of the array of display elements. As explained herein, in various arrangements, the disclosed diffusers can be implemented in conjunction with front-light devices. Light can be introduced by way of a light source disposed along one end of a light guide. For example, the light guide can be formed in a transparent material, such as glass. Light turning features (for example, microprisms) can be shaped within the light guide and can be configured to turn light outward from the light guide. The light can propagate through the light guide from the source to the other end, and light turning features can turn light backward through an output surface towards the diffuser and the array beyond. Light that propagates through the transmissive portion of the diffuser may be scattered at an exit surface of the diffuser and can be reflected by the array of display elements. Light that impinges upon the absorptive portion of the diffuser may be absorbed, thereby blocking light from the inactive elements of the display device. Accordingly, the display devices disclosed herein can advantageously improve the image quality of transmitted image data while also preventing inactive elements from degrading image quality.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 5 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 5 includes two adjacent interferometric MEMS display elements in the form of IMOD display elements 12 (which can correspond to the display elements 101a-101b, 201a-201b, and 301a-301b of FIGS. 1-3). In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 5, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 5 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (for example, chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (for example, of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 5, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 5. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

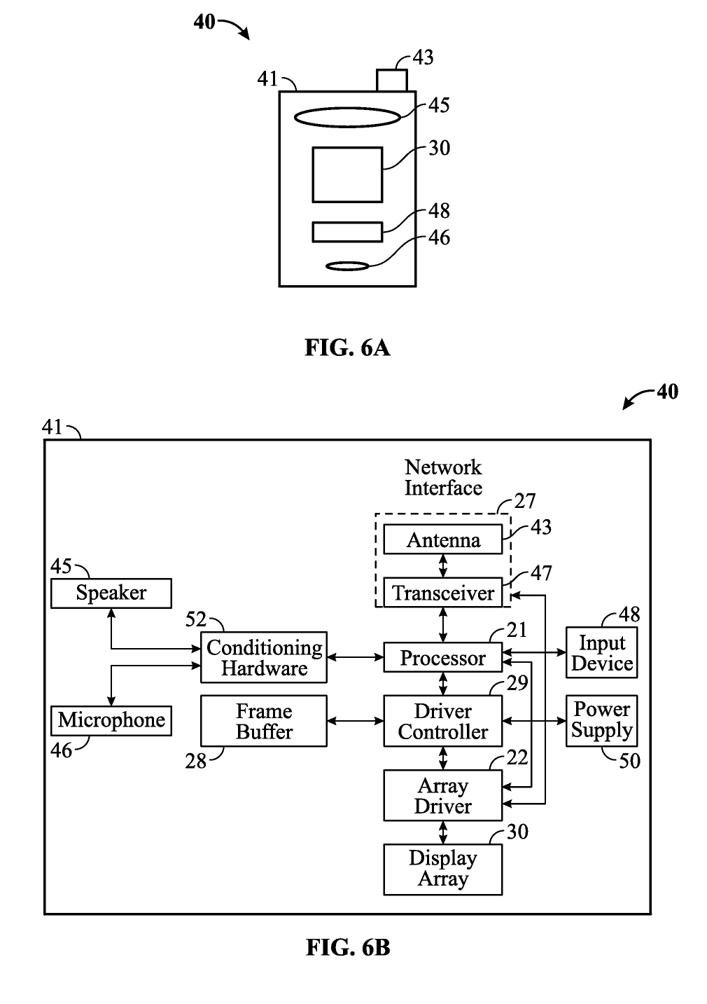

FIGS. 6A and 6B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 6A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 6A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
an array of display elements; and
an optical diffuser disposed forward of the array of display elements, the optical diffuser having a bottom surface facing the array of display elements, the optical diffuser comprising:
a layer of filler material having a first index of refraction; and
a plurality of spaced-apart protrusions having heights substantially perpendicular to the bottom surface and extending into the layer of filler material, at least some of the plurality of protrusions being optically transmissive and having varying heights, each of the plurality of protrusions having an index of refraction different from the first index of refraction.

2. The display device of claim 1, wherein the heights of the protrusions vary substantially randomly.

3. The display device of claim 1, further comprising a light guide over the optical diffuser, the light guide configured to propagate light laterally therein, the light guide comprising a plurality of light turning features configured to redirect light out of the light guide towards the display elements.

4. The display device of claim 3, further comprising an anti-reflective coating disposed between the light guide and the optical diffuser.

5. The display device of claim 1, wherein the optical diffuser includes a transmissive portion and an absorptive portion, each portion comprising protrusions of the spaced-apart protrusions.

6. The display device of claim 5, wherein the transmissive portion is configured to transmit light to active portions of the display elements, and wherein the absorptive portion is configured to absorb light to prevent the light from impinging on inactive portions of the display elements.

7. The display device of claim 5, wherein protrusions in the transmissive portion have a second index of refraction lower than the first index of refraction.

8. The display device of claim 5, wherein protrusions in the absorptive portion have a third index of refraction higher than the first index of refraction.

9. The display device of claim 1, wherein the protrusions are pillars shaped as truncated cones.

10. The display device of claim 1, further comprising:
a display;
a processor that is configured to communicate with the display, the processor being configured to process image data; and
a memory device that is configured to communicate with the processor.

11. The apparatus of claim 10, further comprising:
a driver circuit configured to send at least one signal to the display; and
a controller configured to send at least a portion of the image data to the driver circuit.

12. The apparatus of claim 10, further comprising an image source module configured to send the image data to the processor, wherein the image source module comprises at least one of a receiver, transceiver, and transmitter.

13. The apparatus of claim 10, further comprising an input device configured to receive input data and to communicate the input data to the processor.

14. A display device, comprising:
means for displaying image data; and
means for diffusing light disposed forward of the displaying means, the light diffusing means including means for transmitting light to the displaying means and means for absorbing light directed towards the display device,
wherein the transmitting means scatters light incident on the diffusing means before the incident light impinges on the displaying means, and
wherein the absorbing means absorbs at least some of the incident light before the incident light impinges on the display device.

15. The display device of claim 14, wherein the transmitting means and the absorbing means are formed in the same layer.

16. The display device of claim 15, wherein the transmitting means and the absorbing means each comprise a plurality of spaced-apart protrusions having heights substantially perpendicular to the bottom surface and extending into the same layer of filler material, the protrusions having varying heights, wherein the transmitting means comprises a transmissive portion having protrusions that are optically transmissive, and wherein the absorbing means comprises an absorptive portion having protrusions that are optically absorptive.

17. The display device of claim 16, wherein the displaying means comprises an array of reflective display elements.

18. The display device of claim 17, wherein the reflective display elements comprise one or more interferometric modulator (IMOD) display elements.

19. The display device of claim 16, wherein the heights of the protrusions vary substantially randomly.

20. The display device of claim 16, wherein the filler material has a first refractive index, wherein the optically transmissive protrusions have a second refractive index, wherein the optically absorptive protrusions have a third refractive index, wherein the first refractive index is larger than the second refractive index, and wherein the third refractive index is larger than the first refractive index.

21. The display device of claim 16, further comprising a light guide over the diffusing means, the light guide configured to propagate light laterally therein, the light guide comprising a plurality of light turning features configured to redirect light out of the light guide towards the displaying means.

22. A method of manufacturing a display, the method comprising:
providing an array of display elements;
providing an optical diffuser having a layer of filler material and a plurality of spaced-apart protrusions extending into the layer of filler material, the protrusions having varying heights and an index of refraction different from an index of refraction of the filler material; and
attaching the optical diffuser forward of the array of display elements.

23. The method of claim 22, wherein attaching the optical diffuser includes disposing the optical diffuser between the array of display elements and a transparent substrate.

24. The method of claim 22, wherein the protrusions are formed using a protrusion material, and wherein providing the optical diffuser includes:
etching openings in a base substrate, the base substrate including one of the filler material and the protrusion material; and
filling the etched openings with the other of the filler material and the protrusion material.

25. The method of claim 22, wherein etching openings comprises etching openings having depths that vary substantially randomly.

26. A method of making an optical diffuser, the method comprising:
providing a layer of optically transmissive material having a first refractive index;
forming holes extending into the layer of optically transmissive material, at least some of the holes having varying depths;
filling some of the holes with a second material having a second refractive index lower than the first refractive index; and
filling others of the holes with a third material having a third refractive index higher than the first refractive index.

27. The method of claim 26, wherein filling some of the holes with the second material forms optically transmissive pillars, and filling others of the holes with the third material forms optically absorptive pillars.
